(19) United States
(12) Patent Application Publication
(10) Pub. No.: US 2012/0067778 A1
(43) Pub. Date: Mar. 22, 2012

(54) Multimetallic anionic clays and derived products for SOx removal in the fluid catalytic cracking process

(75) Inventors: Jaime SÁNCHEZ VALENTE, Del. Gustavo A. Madero (MX); Roberto QUINTANA SOLÓRZANO, Del. Gustavo A. Madero (MX); Lázaro Moisés GARCÍA MORENO, Del. Gustavo A. Madero (MX); Rodolfo Juventino MORA VALLEJO, Del. Gustavo A. Madero (MX); Francisco Javier HERNÁNDEZ BELTRÁN, Del. Gustavo A. Madero (MX)

(73) Assignee: INSTITUTO MEXICANO DEL PETROLEO, Mexico City (MX)

(21) Appl. No.: 12/883,357

(22) Filed: Sep. 16, 2010

(51) Int. Cl. C10G 11/04; B01J 21/16

(52) U.S. Cl. 208/124; 502/73

(57) ABSTRACT

The present invention relates to the preparation of Multimetallic Anionic Clays (MACs) through a simple method, which are then shaped by spray-drying into microspheres with adequate mechanical properties, suitable to be fluidized. The microspheres are appropriate for application as additives in the Fluid Catalytic Cracking (FCC) process, i.e. blended with the conventional catalyst, to in situ remove sulfur oxides (SOₓ) from the combustion gases produced in the regeneration stage of the FCC process, when cracking sulfur-containing hydrocarbon feeds. An oxidation promoter is added to the MACs in order to promote the oxidation of SO₂ to SO₃, a key step in SOₓ removal, providing more efficient and versatile materials, which are apt to be used in atmospheres with variable oxygen concentration.

### FIELD OF THE INVENTION

This invention pertains to the simplified preparation of Multimetallic Anionic Clays (MACs) and their shaping by spray-drying into microspheres with adequate physicochemical and mechanic properties, suitable to be fluidized. The microspheres are blended as additives with the conventional catalysts used in the Fluid Catalytic Cracking (FCC) process, in order to decrease sulfur oxides (SOₓ) emissions from the combustion gases generated during said process when cracking sulfur-containing hydrocarbons feeds. The MACs contain an additional metallic component that promotes the oxidation of SO₂ to SO₃, enabling an efficient use of the additives under different oxygen concentrations.

### BACKGROUND OF THE INVENTION

The conversion of heavy crude oil fractions, in particular, gas oils, residue fuel oils or mixtures thereof, through the Fluid Catalytic Cracking process (FCC), produces lighter and more valuable products such as gasoline, diesel fuel and light olefins. The reaction takes place over a Y-zeolite based catalyst, which is in the form of microspheres. The use of such an acid catalyst allows the cracking to occur at a temperature of around 530° C. with a significantly higher selectivity to light distillates and a lower selectivity to gases and coke, compared to the products of non-catalytic thermal cracking process.

In the commercial FCC unit, the cracking reactions essentially occur in the riser, an ascending flow reactor where the feed that is injected at the bottom, vaporizes when contacting the hot catalyst coming from the regenerator and cracks while flowing together with the catalyst particles. Hence, the mixture exiting the riser consists of cracked products and catalyst. These are broadly separated in the disengager of the unit. Further, the hydrocarbons that remain occluded between the catalyst particles are removed in the stripper by means of multiple steam injections to reduce as much as possible the presence of hydrocarbons with relatively high hydrogen to carbon ratio in the regenerator.

During catalytic cracking, cracked products exhibit a larger hydrogen to carbon ratio, in comparison with that of the feed, which inherently results in the formation of carbonaceous side-products denoted as coke. Although the coke deposited on the catalyst surface causes its deactivation and changes its selectivity, it is vital for the process since its combustion provides the necessary heat for preheating/vaporizing the feed and for encouraging the endothermic cracking reactions. Thus, the coked catalyst flows from the stripper to the regenerator where coke is burned off by air injection, i.e., in an oxidant atmosphere, at a relatively high temperature, typically from 640 to 730° C. The regenerated catalyst, whose activity has been restored after removing coke, flows back to the bottom of the riser to start a new cycle of reaction, disengaging, stripping and regeneration.

Feeds processed using FCC consist of hydrocarbon compounds, typically contaminated with a relatively small amount of heteroatoms of sulfur, nitrogen and metals. The sulfur content in FCC feed is variable, usually from 0.1 to 4 wt % and, after cracking, sulfur distributes into the various cracked products. Typically, between 45 wt % and 55 wt % of fed sulfur end up in gaseous products as H₂S, from 35 wt % to 45 wt % stays in liquid products (i.e., gasoline, light cyclic oil and heavy cyclic oil), while between 5 wt % to 15% ends up in coke. Such percentages mainly depend upon feed nature, catalyst formulation and operating conditions.

The flue gas leaving the regenerator of the FCC unit, produced by coke combustion, is composed of products such as CO₂, H₂O, CO, SOₓ, and NOₓ, as well as O₂ and N₂. Sulfur oxides (SOₓ), consisting of SO₂ and SO₃, are produced as a result of burning the sulfur compounds that accompany the coke.

SOₓ are noxious gases that react with atmospheric moisture in the presence of UV light to produce the so-called acid rain, which has negative environmental effects. Being aware of this fact, government agencies worldwide have established very strict environmental regulations to limit SOₓ, emissions to the atmosphere, while researchers work hard to find alternatives to abate them efficiently.

Scientific literature and patents on the FCC process report that SOₓ emissions can be controlled in situ by way of incorporating additives in the form of separate particles which are blended with the conventional catalytic cracking catalyst in low amounts; typically lower than 10 wt %. Additives are, decidedly, a practical and flexible alternative for SOₓ removal as they are added into the FCC unit at any moment to obtain a quick response. This is of particular importance for FCC units considering that the feed quality and, hence, its sulfur content vary continuously. Additives are expected not to modify significantly the base feed conversion and product distribution in the unit.

SOₓ emissions in the FCC process occur through the following chemical reactions:

S_{coke}+O₂->SO₂

SO₂+½O₂ [symbol] SO₃;ΔH_{25° C.}=98.7 kJ/mol

SO₂ conversion into SO₃ is exothermic and hence, thermodynamically, SO₃ formation is favored at a lower temperature. SO₃ formation is also favored with increasing oxygen partial pressure at a given temperature. In the temperature range typical of FCC regenerators, from 640 to 730° C., the Gibbs free energy of this reaction varies from −13.1 to −4.2 kJ/mol, the equilibrium constant declines from 5.6 to 1.6, while the SO₂ to SO₃ molar ratio increases from 0.6 to 1.6, for a stoichiometric SO₂ to O₂ ratio, considering the amount of nitrogen in air. Though the SO₂ to SO₃ molar ratio strictly speaking depends upon the regenerator operating conditions, i.e., temperature, oxygen partial pressure, etc., an approximate value of 9.0 is reported for FCC units, which is considerably far from the values at equilibrium.

A simplified representation of the chemical reactions involved in the removal of SOₓ emission is as follows:

SO₂+½O₂ [symbol] SO₃

MO+SO₃→MSO₄

MSO₄⁺4H₂→MO+H₂S+3H₂O

MSO₄⁺4H₂ [symbol] MS+4H₂O

MS+H₂O [symbol] MO+H₂S

The efficiency of the additives for SOₓ removal is dictated by the combination of several catalytic properties: (i) the capacity to transform SO₂ into SO₃ at the oxidant conditions of the regenerator of the FCC unit; (ii) the ability to chemisorb SO₃ on a metal oxide (MO) resulting in a metallic sulfate (MSO₄) which is stable at the regenerator conditions and, in turn, is susceptible to be transformed into the corresponding metallic sulfide (MS) at the reductive conditions that prevail in the reactor/stripping zone owing to the presence of hydrogen and hydrocarbons and; (iii) the capacity to restore the original metal oxide (MO) either directly from the MSO₄ or through the formation of MS. The reduction of MSO₄ in the riser zone, which occurs in the presence of a hydrogen/hydrocarbons atmosphere, and the hydrolysis of MS, which takes place in the stripper in the presence of steam, produces H₂₅ that leaves the FCC unit together with the main cracking products.

The additive's effectiveness, according to the SOₓ removal scheme described above, depends on a large degree on its capabilities to convert SO₂ into SO₃, and to reduce the metallic sulfate to regenerate the additive. Therefore, it is highly convenient to incorporate an additional metallic component into the additive; rare earths and transition metals, specifically cerium and vanadium oxides, are components commonly employed for this aim. Another parameter that determines the additive's success is its ability to form stable metallic sulfates at regenerator's conditions, in large amounts per unit weight of additive.

The first generation of additives for SOₓ removal exhibited a limited capacity for capturing sulfur due to the nature of the metallic sulfate formed. When very unstable metallic sulfates are formed they decompose in the regenerator itself whereas very stable metallic sulfates are not able to be transformed into the pristine metallic oxide in the reactor/stripper zone. Thus, several research groups in the world developed new materials aimed at modulating the stability of the corresponding sulfate to finally increase the efficiency of additives to remove sulfur oxides.

U.S. Pat. No. 3,699,037 (1972) assigned to Chevron Research Company, for instance, describes the use of calcium compounds, magnesium compounds and mixtures thereof for reducing the SOₓ emission produced in the fluid catalytic cracking process. In this case, the amount of material added to the process is varied depending on the deposition rate of sulfur compounds on the catalyst surface during the reaction.

In U.S. Pat. No. 3,835,031 (1974) assigned to Standard Oil Company, the conventional FCC catalyst is modified by impregnating one or more metal compounds of a Group IIA metal, especially magnesium compounds, followed by calcination, to incorporate from about 0.25 wt % to 5 wt % of the metal or its corresponding metal oxide.

Iacovos A. Vasalos, in U.S. Pat. No. 4,153,534 (1979) assigned to Standard Oil Company, describes a cyclic fluidized catalytic cracking process offering reduced emissions of sulfur oxides contained in the flue gas produced in the regeneration zone. The invention accomplishes sulfur oxides reduction through the usage of solid particles which includes (1) a molecular sieve-type cracking catalyst consisting of a cracking catalyst matrix containing crystalline alumina-silicate distributed throughout the matrix and, (2) a metallic reactant which reacts with a sulfur oxide to form a metal- and sulfur-containing compound in the solid particles. Ideally, the metallic reactant consists of at least one, or a combination of, metallic elements selected from the group consisting of sodium, manganese and copper. Such metallic reactant can be in the form of finely divided particles with an average diameter preferably lower than 50 micron, separate from the molecular sieve-type cracking catalyst or any other support.

U.S. Pat. No. 4,423,019, assigned to Standard Oil Company, discloses sulfur oxides removal from the catalytic cracking regeneration zone by means of using an absorbent which comprises a physical mixture of (1) a particulate cracking catalyst consisting of a crystalline aluminosilicate zeolite distributed throughout a porous alumina matrix and (2) a particulate solid other than cracking catalyst which comprises an inorganic oxide selected from oxides of aluminum and magnesium in association with at least one, or combinations of, element from the group consisting of lanthanum, cerium, praseodymium, samarium and dysprosium.

The performance for SOₓ removal of some materials composed of metals with a basic nature such as magnesium oxide or calcium oxide has been limited since they produce very stable sulfates, which restricts the regeneration of the metallic oxide composing the additive. Besides, such materials in the form of microspheres, i.e., as additives, exhibit a low apparent bulk density (ABD) as well as high attrition index (AI) which can cause some fluidization problems when incorporated into the circulating catalytic cracking unit.

Other materials like Al₂O₃ also showed a low SOₓ removal capacity because the Al₂(SO₄)₃ formed is very unstable at the temperatures that typically exist in the regenerator of the FCC unit.

Metal-containing spinel materials, mainly those based on magnesium aluminate, were further developed as improved solids for SOₓ reduction. Such materials were doped with cerium and vanadium in order to promote oxidation and reduction reactions. For instance, Jin S. Yoo, in the U.S. Pat. Nos. 4,469,589 and 4,472,267 (1984), assigned to Atlantic Richfield Company, refers to a metal-containing spinel to reduce the amount of sulfur oxides emitted from the FCC combustion zone. According to Yoo, good results were obtained after incorporating cerium, 2 to 15 wt %, into the spinel. For MgAl₂O₄ spinel-based additives, there is a relatively high resistance of the corresponding metallic sulfate to be reduced at the conditions of the reactor/stripper which, at the end, causes a rapid deactivation.

In the U.S. Pat. Nos. 5,114,898 (1992); 5,116,587 (1992) and 5,785,938 (1998) of T. J. Pinnavaia et al., processes to remove and later capture sulfur oxides are illustrated. In particular, double metal hydroxides are used as recyclable adsorbents to decrease the SOₓ content of gas effluents from the energy generating plants through mineral coal burning. The adsorbing compositions contain metal components capable of forming metal sulfites and sulfates that are stable at the process conditions and decompose at a higher temperature to regenerate the adsorbing material.

Emmanuel H. van Broekhoven in the U.S. Pat. Nos. 4,866,019 (1989) and 4,946,581 (1990) assigned to Akzo N. V., reports the usage of anionic clays for SOₓ removal in the FCC process. According to the invention, the anionic clay is embedded in a matrix material and then mixed with the conventional cracking catalyst. The anionic clays should be preferably embedded in a matrix material in order to obtain particles with envisaged values of density, attrition resistance and particle size. The use of cerium as oxidant promoter is recommended.

In U.S. Pat. No. 5,750,020 (1998) by Bhattacharyya et al., assigned to AMOCO Co., a collapsed hydrotalcite composition, which may be obtained by calcining a mixed layered hydroxide having monometallic anions on the interlaminar region, is described. This collapsed composition essentially consists of microcrystals represented collectively by the formula: M₂ₘ²⁺Al₂₋ₚMₚ³⁺TᵣO_{7+r′s}, where M²⁺ is a divalent metal, M³⁺ is a trivalent metal and T is vanadium, tungsten or molybdenum. The little crystals are so small they cannot be detected by means of conventional X-ray diffraction techniques; however, high resolution electronic microscopy shows that a considerable portion of the microcrystals corresponds to a solid solution of molecularly disperse aluminum oxide in the crystalline structure of the divalent metal monoxide. Another portion of the microcrystals is constituted of the spinel phase. The collapsed composition adsorbs sulfur oxides exhibiting high absorption levels and high desorption speeds as well as a good capacity to remove nitrogen oxides.

Albert A. Vierheilig, in U.S. Pat. No. 6,028,023 (2000), assigned to Bulldog Technologies U.S.A., Inc., and U.S. Pat. No. 6,479,421 (2002) as well as U.S. Patent Publication No. 2003/0096697 and U.S. Pat. No. 6,929,736 (2005) assigned to Intercat, Inc., claims a method to produce anionic clays out of compounds with a non-hydrotalcite-like structure in the so-called fresh form and to convert to hydrotalcite-like structures after being subjected to an activation procedure disclosed in these patents. This process includes a thermal treatment of a non-hydrotalcite compound followed by hydration in order to form anionic clays with an improved hardness and density compared with other anionic clays prepared by other methods reported in the state of the art. The author proposes the use of these materials doped with cerium and vanadium as SOₓ adsorbents in the FCC process.

In a similar way, William Jones et al. in U.S. Pat. No. 7,576,024 (2009) conceded to Albemarle protect a catalytic composition applicable to SOₓ emissions reduction in the FCC process. This composition comprises an anionic clay and rare earth metals which is prepared via precipitation of divalent and trivalent metals and the rare earth salt(s) to produce a precipitate that is further subjected to calcinations and rehydration.

Anionic clays is a general term that is used to denote materials which are composed of divalent and trivalent cations in a lamellar structure with a general formula:

[M²⁺₁₋ₓM³⁺ₓ(OH)₂](Aⁿ⁻)_{x/n}.mH₂O

The presence of a trivalent cation produces positive charges in the sheets, which are compensated by interlaminar anions such as carbonates, sulfates, chlorides, nitrates, etc. The M²⁺/M³⁺ molar ratio in these materials may vary from 1.7 to 5 and, additionally, the original bivalent or trivalent cations can be substituted by others.

The synthesis of the anionic clays is usually performed by way of the co-precipitation of metallic salts. A typical preparation procedure consists of mixing an aqueous solution of magnesium and aluminum salts, e.g., nitrates or chlorides, with a solution containing sodium carbonate/sodium hydroxide, under continuous agitation. The precipitate formed is subjected to heating for several hours at a temperature in the range 60 to 200° C.

In nature, many minerals which are isomorphs to anionic clays have been found. Such minerals characterize by having different stoichiometries, with more than one anion or more than two cations, or with small quantities of cations in the brucite-like interlaminar region. The crystalline structures include pyroaurite, sjogrenite, hydrotalcite, stichtite, reevesite, eardleyite, manasseite, barbertonite, takovite, desautelsite, and hydrocalumite, among others. In order to understand the structure of these compounds, it is necessary to take the structure of brucite, Mg(OH)₂, as a reference. In this solid, Mg²⁺ is octahedrally coordinated to six hydroxyl groups, which, upon sharing their edges, form infinite layers. These layers pile up one on top of the other and are held together by hydrogen bonds. When Mg²⁺ is replaced by Al³⁺, for instance, the presence of the aluminum atoms produces positive charges in the structure which are compensated for by interlaminar anions together with water molecules. The most common anions are CO₃²⁻, but they can also be NO₃⁻, OH⁻, Cl⁻, Br⁻, I⁻, SO₄²⁻, SiO₃²⁻, CrO₄²⁻, BO₃²⁻, MnO⁴⁻, HGaO₃²⁻, HVO₄²⁻, ClO₃⁻, ClO₄⁻, IO₃⁻, S₂O₃²⁻, WO₄², [Fe(CN)₆]³⁻, [Fe(CN)₆]⁴⁻, (PMO₁₂O₄₀)³⁻, (PW₁₂O₄₀)³⁻, V₁₀O₂₆⁶⁻, Mo₇O₂₄⁶⁻, etc.

Specialists in this field recognize that the anionic clays are commonly referred to as “mixed metal hydroxides.” This denomination was derived from the fact that, as was noted earlier, the positively charged layers of the metallic hydroxides can contain two or more different metallic cations at different oxidation states, such as Mg²⁺, Ni²⁺, Zn²⁺, Al³⁺, Fe³⁺, Cr³⁺, etc. Additionally, and given that the X-ray diffraction patterns of many of the anionic clays are similar to the natural mineral known as hydrotalcite, [Mg₆Al₂(OH)₁₆] (CO₃).4H₂O, they are commonly called “Hydrotalcite-like compounds”. This term has been widely used in the scientific and patent literature for many years. In fact, the terms “anionic clays”, “mixed metal hydroxides”, “hydrotalcite-like compounds,” and “layered double hydroxides,” are closely related to each other and are used indistinctly.

Briefly, the term “hydrotalcite-like” is defined and used in a manner consistent with the literature, given that hydrotalcite, strictly speaking, refers to the anionic clay which has been part of numerous studies in the last decade. Unless otherwise indicated, the term anionic clays with the understanding that this term includes all natural and synthetic anionic clays, the aforementioned hydrotalcite, as well as any member of the class of materials designated “hydrotalcite-like compounds”. Due to its frequent use in this document, the authors will abbreviate the term “multimetallic anionic clays” as “MACs.”

It is known in the state of the art that anionic clays decompose in a predictable manner when heated without exceeding a certain temperature limit. The materials resulting from such decomposition can be rehydrated and, optionally, supplied with various anions different from the one originally located in the interlaminar region and from those removed during heating, to reproduce the original anionic clay or a very similar one. The decomposition products are frequently referred to as “collapsed” or “meta-stable” anionic clays. Nonetheless, if these collapsed or meta-stable materials are heated to temperatures above 800° C., the decomposition products of said anionic clays will not be able to be rehydrated and/or reconstituted to their original structure.

The collapsed anionic clays' structure corresponds to a solid solution consisting of a homogeneous mixture of the metallic oxides. An advantage of incorporating different metallic cations into the laminar structure of the clays is that a uniform distribution of these cations, when forming a solid solution or a mixed oxide, is achieved. The precursor laminar structure is completely regenerable as long as the pre-treatment temperature does not exceed 800° C. to avoid the formation of the spinel phase and, thus, conserving the so-called “memory effect” that is characteristic of this type of materials.

Due to the large variety of applications at large, commercial scale, it is a key point to have materials produced not only through a simple and economical route but also via a procedure that fulfills environmental requirements.

The Mexican Patent Application No. MX/a/2007/003775, U.S. patent application Ser. No. 11/926,656 and U.S. patent application Ser. No. 12/631,327 (U.S. Pat. No. 7,740,828 B2) with filing dates of Mar. 29, 2007; Oct. 29, 2007 and Dec. 4, 2009, by Jaime Sánchez-Valente et al., which are hereby incorporated by reference in their entirety, describe a procedure for obtaining a series of mixed multimetallic oxides derived from hydrotalcite-type compounds. In this procedure, a simple method that allows incorporating a third and a fourth cation into the laminar structure of the hydrotalcite precursors is disclosed. Such a method consist of (1) dissolution in water of the water-soluble metallic precursors, bivalent and/or trivalent; (2) dispersion and homogenization of the water-insoluble metallic precursors, bivalent and/or trivalent, in water by means of a high speed disperser to produce very small, reactive particles; (3) mixing the solution obtained in (1) and the suspension produced in (2) using a high speed disperser to produce particles as small as possible; (4) aging and then drying the suspension resulting in step (3). In stage (2) the pH of the suspension can be optionally adjusted depending upon the nature of the water-insoluble metals. A relevant aspect of this process is the usage of readily available, easily handled materials, while the resulting product does not require further steps of washing and purification.

U.S. Pat. No. 7,740,828 B2 dated Jun. 22, 2010 and assigned to Instituto Mexicano del Petróleo, refers only for a multimetallic anionic clays (MACs) characterized in that the laminar metallic hydroxides have at least three of three different metal cations forming part of the anionic clay's layers and have the following formula: [M(II)₁₋ₓM(III)ₓ(OH)₂]Aⁿ⁻_{x/n}).mH₂O, where [M(II)]/[M(III)], is the molar ratio between the divalent cations and the trivalent cations and is found between 0.5-10; M(II) represents one or a combination of two or more elements from group 2, 6-12 and 14 on the periodic table with valence equal to two; M(III) represents a combination of two or more elements from group 4-9, 13, Ce, and La, with valence equal to 3 and different from M(II); A represents any anion located between the layers composed of the aforementioned cations; n− represents the interlaminar anion's negative electronic charge and may be from −1 to −8; m represents the water molecules present as hydration water or as water present in the interlaminar region and can be from 0-2, and, x=0.09 to 0.67.

### SUMMARY OF THE INVENTION

One feature of the current invention is, therefore, an improved procedure to produce multimetallic anionic clays (MACs) that are applied in the abatement of SOₓ emissions which are generated in the regeneration step when converting, via catalytic cracking, sulfur containing hydrocarbon feeds. Following the procedure, the effective incorporation of metallic cations into the laminar structure of clays is achieved as cations with a similar atomic ratio are employed.

Another important aspect of the present invention is the incorporation of an additional metallic compound, cerium, which accelerates the oxidation of SO₂ into SO₃, a crucial step in SOₓ reduction. Adding cerium during the formation of the laminar structure leads to a high degree of metal dispersion and, after calcination, the corresponding cerium oxide is uniformly distributed throughout the “collapsed structure”. It is believed that “collapsed structures” exhibit improved catalytic properties related to the SOₓ reduction compared with those of metallic cations that have been impregnated or deposited over the solid.

Thus, this invention involves compositions of multimetallic anionic clays materials, their preparation and use for removing SOₓ gases generated during the combustion of sulfur compounds during the regeneration stage of the FCC process. The inclusion of a metallic component that is capable of enhancing the rate of the SO₂ to SO₃ oxidation allows to use the compositions under combustion conditions with variable oxygen content. It is a particular aspect of the present invention the fact that such material compositions are shaped, via spray drying without requiring the addition of binder materials, into microspheres which are susceptible to fluidize together with the conventional catalytic cracking catalyst in circulating FCC units. More specifically, these microspheres are used as additives for removing in situ the SOₓ emissions generated in the regenerator of FCC units when converting sulfur containing hydrocarbon feeds.

A particular feature of the additives employed in SOₓ emissions abatement in the FCC process is associated to their efficiency, a parameter that considers the mass of SOₓ removed related to the mass of additive employed. Improvements in the formulation of such additives are compulsory so as to increase their capacity of controlling SOₓ emissions.

One feature of the present invention is the production of Multimetallic Anionic Clays (MACs) as precursors of multimetallic mixed oxides with an enhanced capacity of reducing sulfur oxides contained in combustion gases.

Another feature of this invention is the production of more efficient and versatile materials by incorporating cerium as an oxidation promoter in the MACs. Adjusting the amount of this metal allows materials to be used in atmospheres with a variable concentration of oxygen, an important parameter in the operation of the regenerator of commercial FCC units.

Yet another feature of the current invention is to provide shaped materials with adequate physical and mechanical properties, to be used as additive, i.e., blended with the conventional fluid catalytic cracking catalyst, for controlling in situ the SOₓ emission produced during the regeneration stage in the conversion of sulfur containing hydrocarbon feeds via fluid catalytic cracking.

MACs, which are intermediate products of mixed multimetallic oxides, are prepared using metallic oxides as well as a nitrate metallic source, the latter added to adjust pH required for the formation of the corresponding multimetallic hydrotalcite. Using nitrates is advantageous since these are easily eliminated and/or incorporated during the heating and/or activation processes which avoids the problems associated with the use of alkaline metal hydroxides or carbonates (KOH, NaOH, K₂CO₃, Na₂CO₃, etc.).

The present invention involves the incorporation of an additional metallic component into MACs for promoting the oxidation of SO₂ to SO₃, a crucial step in the mechanism of sulfur oxides removal. Such a metallic component can be iron or cerium, or a mixture thereof. It is, therefore, another relevant aspect of the present invention to produce a material composition with the following characteristics: (a) an improved SOₓ adsorption capacity, and (b) and enhanced adsorption and regeneration speed of the calcined products from the multimetallic anionic clay when incorporating a third or fourth cation into the sheets of these precursor materials.

An additional aspect of this invention is to provide materials in the form of separate microspherical particles, i.e., as additives, with the adequate physical and mechanical properties to be blended with conventional cracking catalysts for controlling SOₓ emissions in fluid catalytic cracking. The additives should exhibit values of average particle size, apparent bulk density and attrition index similar to those disclosed by conventional catalytic cracking catalysts, considering that they will circulate together in circulating FCC units.

The MACs prepared according to the invention are represented by the general formula:

[MgₓAl_{y}Fe_{z}(OH)₂](Aⁿ⁻_{(y+z)/n})[CeO₂]ₚ.mH₂O,

where Mg, Al and Fe are metal cations that constitute the layers of the anionic clay. Meanwhile, Ce, the oxidant promoter, is highly dispersed in the solid in the form of cerium oxide. Aⁿ⁻ denotes any anion located between the layers composed of the aforementioned cations; n represents the interlaminar anion's negative electronic charge that may be from −1 to −8; m stands for the water molecules present as hydration water or as water present in the interlaminar region and may range from 0 to 2; while x=0.667 to 0.833, y=0.001 to 0.275, z=0.055 to 0.256, p=0.029 to 0.110.

The synthesis of the multimetallic anionic clays of the present invention involves the following stages:
(1) One, two or more water-soluble divalent and/or trivalent metal precursors including Ce, an oxidant promoter, are dissolved in water.
(2) One, two, or more water-insoluble trivalent metal precursors in the powder form are incorporated into the solution obtained in stage (1), the resulting mixture is stirred at a rate in the range 100-1000 rpm, preferably 300-600 rpm, for 0.5-3 h, preferably from 1 to 2 h, and at 10-100° C., preferably 25-40° C., while controlling the water to solid mass ratio to ultimately produce a gel.
(3) One, two or more water-insoluble divalent metal precursors are added and mixed in acidified water containing a weak acid, e.g., acetic acid, formic acid, etc. The mixture is stirred at a rate in the range 100-1000 rpm, preferably 300-600 rpm, for 0.5-3 h, preferably from 1 to 2 h, and at 10-100° C., preferably 25-40° C.
(4) The suspension produced in stage (3) and gel formed in stage (2) are mixed to induce the formation of anionic clays maintaining the pH between 6 and 12, preferably between 8 and 10, and the temperature between 80 and 200° C., preferably between 100 and 150° C., stirring the mixture at a rate of 100-1000 rpm, preferably 300-600 rpm, while the mixture passes through an in-line high shear mixer, for 1-10 h, preferably for 2-5 h.
(5) The slurry produced in stage (4) is spray dried with hot air to obtain microspheroidal particles suitable to be fluidized.
(6) Microspheres obtained in stage (5) are calcined at a temperature in the range 300 to 1000° C., preferably between 450 to 732° C., under flow of air, oxygen, nitrogen or combinations thereof.

Apart from exhibiting improved catalytic properties for SOₓ reduction, the product obtained from stage (6) must have adequate values of particle size, density and attrition resistance to be used as SOₓ reducer additive in the FCC process. In the commercial FCC unit, catalyst (additives) losses are inevitable due to the continuous circulation of the particles and, therefore, fresh catalyst (additive) is continuously added to maintain a constant catalyst inventory and a constant additive concentration. Suitable values of density and attrition resistance are aimed at reducing the additive addition rate.

### BRIEF DESCRIPTION OF THE DRAWINGS

In order to show the structure and the physical properties of the raw materials as well as the mechanical and catalytic properties of the additives, reference is made to the figures herein included.

FIG. 1 exhibits the Scanning Electron Microscopy (SEM) images of microspheres prepared according to Examples 1 and 2, after spray drying.

FIG. 2 is the Scanning Electron Microscopy image and two-dimensional Energy Dispersive X-ray Spectroscopy image (EDS, also known as Chemical Mapping) of a microsphere sample prepared in accordance with Examples 1 and 2.

FIG. 3 is the X-ray diffraction (XRD) pattern of an uncalcined (i.e. fresh) spray dried material prepared in compliance with Examples 1 and 2.

FIG. 4 shows the X-ray diffraction (XRD) patterns of a sample prepared according to Examples 1 and 2, spray dried and further calcined at 732° C. for 4 h.

FIG. 5 is a graph showing the evolution of SO₂ concentration in the combustion gas emissions of the pilot FCC unit, operating at partial combustion mode, from the activity test described in Example 3, before and after adding the additive in Example 1, compared to the corresponding response of a commercial additive used as Reference.

FIG. 6 shows the evolution of SO₂ concentration in the combustion gas emissions of the pilot FCC unit, operating at full combustion mode, from the activity test described in Example 4, before and after adding the additive of Example 2, compared to the corresponding response of a commercial additive used as Reference.

FIG. 7 presents the evolution of the SO₂ emissions of the Davison Circulating Riser (DCR) pilot unit, operating at partial combustion mode, from the stability test described in Example 5 before and after the periodical additions of 15 g of the additive of Example 1.

FIG. 8 displays the evolution of the SO₂ emissions of the DCR pilot unit, operating at full combustion mode, from the stability test described in Example 6 before and after the periodical additions of 15 g the additive of Example 2.

### DETAILED DESCRIPTION OF THE INVENTION

This invention is directed to a process for obtaining a series of mixed multimetallic oxides derived from multimetallic anionic clays (MACs) and their use as adsorbent materials, capable of being regenerated, for abating the sulfur oxides (SOₓ) contained in gas effluents, in particular, in the combustion gases emitted by the regeneration section of the fluid catalytic cracking process.

The adsorbent materials or multimetallic anionic clays disclosed in this invention are represented by the following general formula:

[MgₓAl_{y}Fe_{z}(OH)₂](Aⁿ⁻_{(y+z)/n})[CeO₂]ₚ.mH₂O

In this formula, Mg, Al and Fe are metal cations that constitute the layers of the anionic clay while Ce, the oxidant promoter, is highly dispersed in the solid in the form of cerium oxide. Aⁿ⁻ denotes an anion located between the layers composed of the aforementioned metal cations; n represents the interlaminar anion's negative electronic charge that may be from −1 to −8; m stands for the water molecules present as hydration water or as water present in the interlaminar region and can be from 0 to 2; while x=0.667 to 0.833, y=0.001 to 0.275, z=0.055 to 0.256, p=0.029 to 0.110.

This invention includes a procedure to produce a solid solution and/or a series of multimetallic mixed oxides to be used as SOₓ emissions adsorbents. A particular aspect of the invention is shaping such solids by spray drying to produce microspherical bodies with adequate mechanical properties such as apparent bulk density and attrition resistance to circulate in a fluidized bed. It is, therefore, a distinctive aspect of this invention the use of these bodies as SOₓ emissions reduction additives in fluid catalytic cracking units during the conversion of sulfur containing hydrocarbon feeds.

In accordance with this invention, divalent cation precursors, such as: Mg(NO₃)₂.6H₂O, MgO, Mg(OH)₂, etc., and those of the trivalent cations like boehmite, bayerite, gibbsite, Al(NO₃)₃.9H₂O, Fe₂O₃, Fe(NO₃)₃.9H₂O, etc., are incorporated into a reactor where reaction conditions are adjusted in order to obtain a MAC. The reaction can be carried out using a diverse range of operating conditions aimed at producing compounds with a laminar structure.

The invention involves the preparation of MACs through the dissolution of a divalent and/or a trivalent metal salt soluble in water. The dissolution will produce an adequate environment for incorporating the insoluble divalent and/or trivalent metal's precursor, which will ultimately result in the formation of the anionic clay.

The invention also encompasses the use of metal precursors that, upon dissolving, produce acid solutions whose pH can be modulated in accordance with the metal precursor's concentration and, thus, allowing the peptization of an aluminum source, particularly boehmite or bayerite. In this context, this step avoids the usage of organic or inorganic acids that would introduce an additional step into the process. Moreover, the concept that the reaction mixture's pH can be adjusted if needed is introduced. This is achieved by increasing or decreasing the quantity of initial divalent and/or trivalent metal source as well as the quantity of water used as a reaction medium. The invention includes the use of weak acids and bases as a means to adjust the pH (if required) of the precursor reaction mixtures for the formation of the anionic clays described herein. The organic and inorganic acids or bases may be added to the slurry at the beginning, middle, or end of the reaction, independently of the used reagents. Among the recommended acids and bases are formic acid, acetic acid, nitric acid, oxalic acid, ammonium phosphate, phosphoric acid, ammonium hydroxide, urea, ammonium carbonate, and ammonium bicarbonate. Since these acids and bases do not introduce undesirable ions into the reaction mixture, the final product does not require washing.

A particular aspect of this invention is that either before being added to the reaction mixture or when being already part of the reaction mixture, the insoluble components may be dispersed or homogenized in an aqueous medium. The term disperse is defined as any method that results in a particle size reduction. Such a reduction in particle size produces, at the same time, the formation of active surfaces and/or heating. To this end, the use of instruments such as those that can introduce ultrasound waves into the slurry, ball mills, high shear mixers, colloidal mixers, and electric transducers can be used.

In this invention, particular attention is paid to the amount of water required in the preparation of MACs. This point is addressed by controlling the water/solid ratio, that is, the mass of water used to prepare the reaction mixture in relation to the mass of solid precursors. The water to solid mass ratio may range from 0.1:1 to 100:1, more preferably between 5:1 and 20:1. Due to the existing compromise between the quantity of water and the ability of the soluble and insoluble compounds to be dispersed, it is essential to maintain a strict control over these parameters. Similarly, controlling the water to solid mass ratio is very convenient to avoid wasting the aqueous solvent during filtering and/or drying processes, thus including an additional issue to the economy of the synthesis procedure described in this invention.

The composition of the present invention includes a rare earth metal that works as oxidant promoter, which is responsible of the transformation of SO₂ to SO₃, a key step in SOₓ reduction. The rare earth metal is added in an amount between 0.05 and 40 wt %, preferably from 5 to 30 wt %, more preferably between 10 and 20 wt %, calculated as the total amount of the rare earth oxide per total amount of MAC. The preferred rare earth metal is cerium in the free or in the bound form. Cerium may be incorporated into the SOₓ removal compositions by dissolving a cerium salt, e.g., cerium nitrate, together with the soluble salts employed during the preparation of the anionic clay. The latter is further subjected to a thermal treatment at a temperature in the range 400-1200° C., more preferably between 450 to 800° C.

### Preparation Conditions

According to the invention, MACs preparation can be carried out under “thermal” or “hydrothermal” conditions. Within the boundaries of this invention, the term “thermal” implies that the reaction temperature lies in the range 0 to 100° C. under air atmosphere or under any other atmosphere, at atmospheric pressure. The term “hydrothermal” denotes that the reaction is effectuated above 100° C. at pressures higher than the atmospheric one.

The methodology for preparing MACs involves the following steps:
(a) Dissolve a water-soluble divalent and/or trivalent metal precursor maintaining a water to solid mass ratio between 0.1 to 100, preferably from 5 to 20. This will allow to 1) provide the necessary amount of divalent and/or trivalent cations for the formation of the multimetallic anionic clay, and 2) to supply the necessary characteristics to the reaction medium in order to facilitate the reaction between the soluble and insoluble precursors.
(b) Incorporate a cerium salt together with the water soluble metallic precursors in (a).
(c) Add, to the solution of the previous step, a water insoluble divalent and/or trivalent metal precursors in powder or slurry form, or a combination of both. Homogenize the reaction mixture by agitation from 100 to 1000 rpm, preferably 300-600 rpm, keeping the temperature between 10 and 100° C., preferably 25 to 40° C., from 0.5 to 3 h, preferably between 1 and 2 h, at atmospheric pressure in air or under any other gas stream, to produce a gel.
(d) Disperse, in acidified water containing a weak acid (e.g., acetic acid, formic acid, nitric acid, or combinations thereof), one, two or more divalent metallic precursors, in powder form. The mixture is stirred at a rate in the range 100-1000 rpm, preferably 300-600 rpm, for 0.5-3 h, preferably from 1 to 2 h, and at 10-100° C., preferably 25-40° C.
(e) Blend the gel obtained in step (c) with the suspension of step (d) maintaining the pH of the mixture between 6 and 12, preferably between 8 and 10, and the temperature between 80 and 200° C., preferably between 100 and 150° C., stirring the mixture at a rate of 100-1000 rpm, preferably 300-600 rpm, while the mixture passes through an in-line high shear mixer, for 1-10 h, preferably for 2-5 h, to induce the formation of MACs.
(f) The pH of the mixture in (e) can be optionally adjusted by adding a recommended weak acid or a weak base, e.g., formic acid, acetic acid, nitric acid, oxalic acid, ammonia phosphate, phosphoric acid, ammonium hydroxide, urea, ammonium carbonate, ammonium bicarbonate, etc. These acids and bases do not incorporate undesirable ions to the mixture.
(g) The slurry that is produced in step (e) is spray dried in order to shape the multimetallic anionic clays in the form of microspheroidal particles.
(h) Microspheres produced in step (g) are calcined at 300 to 1000° C., preferably at 450-732° C. for 1-24 h, preferably 4-8 h, in the presence of air, oxygen, nitrogen, or mixtures thereof to produce a solid solution composed of multimetallic mixed oxides.
(i) Optionally, the product of step (i) can be rehydrated in an aqueous medium between 50-100° C., preferably between 60-90° C., for a period of 0.1-24 h, more preferably between 4-18 h, in order to restore the original multimetallic anionic clay. In this rehydration process the aqueous medium may contain anions other than those used as precursors in the preparation procedure of MACs.

Microspheres produced in step (h) exhibit an average particle size between 20 and 200 microns (determined by the ASTMD-4464 method), preferably between 40 and 120 microns, an apparent bulk density (ABD) between 0.5 and 1.0 g/cm³ (according to method ISQ 941.02), preferably 0.5 to 0.9 g/cm³, and more preferably between 0.8 and 0.9 g/cm³ and an attrition index (AI) of 1 to 4, and preferably below 3 (in agreement with method ASTM-D-5757). Suitable values of these mechanical properties are critical since shaped solids produced in accordance with this invention will be utilized as SOₓ reducer additives in the fluid catalytic cracking process that is in charge of converting sulfur-containing hydrocarbon feeds.

Microspheres of MACs prepared and shaped according to this invention were subject to characterization in order to determine the corresponding chemical composition, crystalline phases and morphology of the particles. Mechanical properties of microspheroidal bodies, in particular, apparent bulk density (ABD) and attrition index (AI), which are parameters associated with an adequate fluidization, were also determined. Samples, in particular, were analyzed by Scanning Electronic Microscopy (SEM), Energy Dispersive X-ray Spectroscopy (EDS), X-ray diffraction (XRD) and Inductive Coupled Plasma (ICP).

An additional, salient aspect of the invention is the catalytic properties of the additives produced according to the present invention for abating in situ the SOₓ emissions produced in the regenerator of FCC units during the catalytic cracking of industrial hydrocarbon feeds. The feed processed in catalytic cracking contains a relatively low amount of heteroatoms of sulfur and, after the cracking reaction, part of this sulfur ends up in coke. The latter deposits on the surface of the catalyst and then must be removed in the regenerator of the FCC unit via combustion with air to restore the catalyst activity. The product of this combustion process contains, among other gases, SOₓ. The multimetallic anionic clay of the invention is particularly suitable in a cracking process for a hydrocarbon feed containing 0.1 to 5.0 wt % sulfur.

In the cracking process, the multimetallic anionic clay is added in an amount with the cracking catalyst to reduce the SOₓ about 60 to 100% compared to the cracking process without the multimetallic anionic clay. The multimetallic anionic clay is able to remove about 50 to 185 ppm SO₂ per gram of the multimetallic anionic clay and reduce the SOₓ by about 0.7 to 2.7 ppm SO₂ per gram of the multimetallic anionic clay per minute. The multimetallic anionic clay in an amount of 3 wt % based on the total weight of the catalyst does not shift the yield to dry gas in more than 4%, does not modify the yield to LPG in more than 6%, does not change the yield to gasoline in more than 4% and dos not modify the yield to coke in more than 3% relative a baseline value of a catalytic cracking catalyst without the multimetallic anionic clay of the invention.

In the fluidized catalytic cracking process, said microspherical additives together with the main cracking catalyst travel cyclically from the regenerator to the riser and from the riser to the stripper. In the regenerator of the unit, where a temperature over 650° C. and an oxidant atmosphere prevail, additives chemisorb SOₓ contained in the combustion gases produced during the regeneration of the coked catalyst. The additives are used in order to meet the environmental regulations by reducing SOₓ emissions, and their presence in the FCC unit catalyst inventory does not alter base feed conversion and products distribution.

Some of the examples demonstrate the effectiveness of the additives produced according to the current invention for SOₓ reduction present catalytic results of pilot scale tests during the catalytic cracking of a sulfur-containing industrial feed. For this aim, a DCR (Davison Circulating Riser) pilot unit was used. This unit, which exhibits hydrodynamics that closely resemble those of an industrial FCC unit, emulates the reaction, stripping and regeneration steps that cyclically occur in industrial catalytic cracking process. This unit is equipped with a riser having a length to diameter ratio of about 2000, with a maximum catalyst inventory of up to 4 kg and a feed process capacity between 0.35 and 1.5 kg/h corresponding to a catalyst to oil ratio from 3.0 to 11.0 wt/wt. Feed can be preheated up to 400° C. whereas the reaction temperature can reach values as high as 600° C.

In a typical DCR run, a conventional catalyst is loaded into the unit and then fluidized with nitrogen. Once a proper catalyst fluidization is achieved, the feed is injected whilst the operating conditions are set to the defined values. The feed, entering the bottom of the riser as finely atomized particles, vaporizes and then cracks while flowing up together with the hot catalyst coming from the regenerator. The cracked products leaving the riser are separated from the coked catalyst by means of a couple of cyclones and then the catalyst still containing some remaining hydrocarbons drops to the stripper where occluded hydrocarbons are removed by steam injections. The spent catalyst travels to the regenerator where the coke deposited on its surface is burned by combustion with air. Cracked products enter a stabilizer column that separates gases from liquids maintaining the temperature below −12° C. Liquid products composed of C₅+ hydrocarbons leave the bottom of the stabilizer column whereas gaseous products consisting of C₁-C₄ hydrocarbons exit from the top. The liquid product is accumulated in collection pots, quantified and then analyzed via gas chromatography. Gaseous products are measured in a wet test meter and then analyzed on line via gas chromatography. Combustion gases containing CO₂, CO, SOₓ, O₂, and NOₓ are measured in a wet drum gas meter equipped with a pulse generator to transmit a signal to the control system and then analyzed on-line via specific analyzers.

The composition of combustion gases was determined on-line by using California Analytical Instruments analyzers. CO₂, CO and SO₂ were analyzed via infrared detectors, O₂ via paramagnetics and NOₓ by chemiluminescence. In order to monitor feed conversion and products distribution full mass balances were performed. This requires determining the composition of the riser effluent which consists, after the separation in the stabilizer column, of two different cuts, i.e., gases and liquids. The former composed of hydrogen, H₂S, C₁ to C₄ hydrocarbons and a small amount of non-condensed gasoline (mainly C₅-C₆) was analyzed by gases chromatography (GC) via the gases refinery method. The liquid product composed of gasoline, light cyclic oil (LCO) and heavy cyclic oil (HCO) was also subjected to GC analysis via the simulated distillation method.

The catalytic performance of the additives produced according with the invention, was evaluated in a pilot unit. The additive flows together with a conventional cracking catalyst, thus emulating what occurs in industry. Additives can be added in a variable amount, between 0.5 and 5 wt % of the total catalyst inventory. The tests were carried out during the conversion of an industrial feed corresponding to gas oil composed of heavy hydrocarbons with a boiling point range between 200 and 600° C., and sulfur content from 0.1 to 4 wt %. Operating conditions were selected to coincide with values typical of commercial operation e.g., reaction temperature, 450-600° C.; feed preheating temperature, 150-400° C.; regenerator dense phase temperature, 640-720° C.; and catalyst to oil ratio, 4-12 kg/kg. The regenerator of the pilot unit was operated with excess of oxygen relative to the amount required by stoichiometry to burn coke, i.e., the full combustion mode, and with a deficiency of oxygen, i.e., the partial combustion mode. It is important to take into account that, in the mechanism of SOₓ removal by additives, a crucial step is the oxidation, in the regenerator, of SO₂ to SO₃, the latter oxide being the main precursor of the corresponding metallic sulfate. In such a reaction, according to thermodynamic equilibrium, increasing the partial pressure of oxygen shifts the reaction to the formation of SO₃.

In summary, catalytic properties of the additives of the present invention were measured for SOₓ abatement in the fluid catalytic cracking process at the pilot scale through two different protocols: (i) activity tests and, (ii) stability tests. The examples included in the present document provide detailed information related to both tests, which provides data to quantify the performance of the additives for SOₓ reduction. For this aim, the following set of parameters were defined and calculated, on the basis of the SOₓ remissions pilot plant data: % SOₓ reduction, SOₓ adsorption capacity, deactivation rate and SOₓ emissions reduction efficiency.

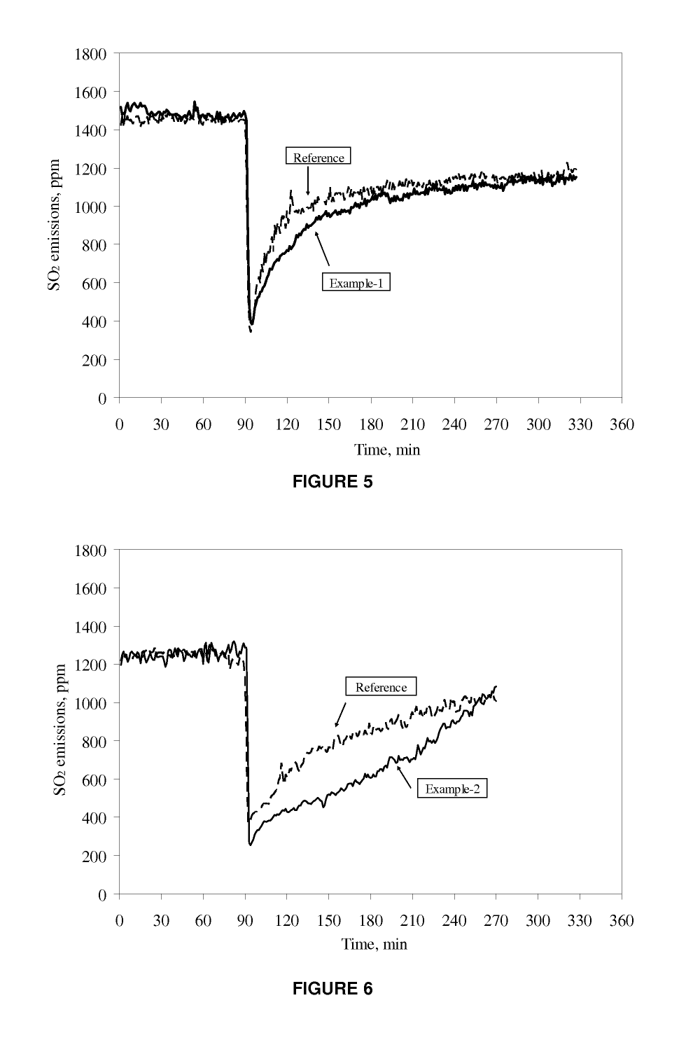

FIG. 5 and FIG. 6 show that the additives prepared according to the present invention are effective for the removal of SOₓ contained in the combustion gases produced during the regeneration step in the pilot unit. FIG. 5, in particular, provides evidence of the good capacity of the additives for SOₓ removal even when the pilot unit regenerator is operated with a deficiency of oxygen related to the value required by stoichiometry to burn coke, namely, the partial combustion mode. In the case of additives operated in atmospheres with oxygen deficiency, a higher load of oxidation promoter appears to increase the conversion rate of SO₂ into SO₃, compensating this way the effect of the partial pressure of oxygen, cfr. Table 7. Furthermore, accounting for the values of the SOₓ reduction parameters presented in Table 6, the behavior of the additives prepared according to the present invention is comparable or even better than that of a commercial additive used as reference.

In terms of main cracking, stability tests disclosed in Examples 5 and 6 and more specifically in Example 7 also show that the additives prepared in accordance with the present invention did not alter in a significant manner base feed conversion and product distribution, as displayed in Table 8. Deviations in the yield to gasoline, the most important product in economic terms; gases, which directly affects the performance of the wet gas compressor; and coke, which has a crucial role in the thermal balance, are practically negligible. Furthermore, the additives described in the present invention can be regenerated in the riser section of the FCC unit, in contact with hydrogen and light hydrocarbons.

### EXAMPLES

Once the basic aspects related to the present invention have been outlined, a set of examples are given to illustrate specific embodiments, although the invention should not be considered to be limited to said examples.

### Example 1

This example describes preparation and shaping of a MAC to be used as additive for reducing SOₓ emissions in conditions of oxygen deficiency related to the operation in partial combustion mode of the regenerator of fluid catalytic cracking units. 62.2 g of acetic acid (85 wt % purity) are dissolved in 1.92 L of H₂O. Then, 376.84 g of MgO are added and the mixture is stirred at 500 rpm for 1 h (A). 364.33 g of Fe(NO₃)₃.9H₂O as well as 377.69 g of cerium nitrate solution (22.77 wt % Ce) are dissolved separately in 4.83 L of water Once the iron nitrate has dissolved, 154.69 g of HiQ-31 boehmite are added and the resulting mixture is stirred at 500 rpm for 1 h (B). The gel product (B) is mixed with the product (A). Temperature is maintained at 100° C. and the mixture is stirred at 500 rpm while it is passed through an in-line high shear mixer for 3 h. The produced slurry is then spray dried with hot air at 400° C. and a feed pressure of 120 psi in order to evaporate the aqueous phase. Microsphere particles obtained by spray drying are calcined at 732° C. for 4 h. Tables 1-3 report the physicochemical and mechanical properties of the product obtained in this example.

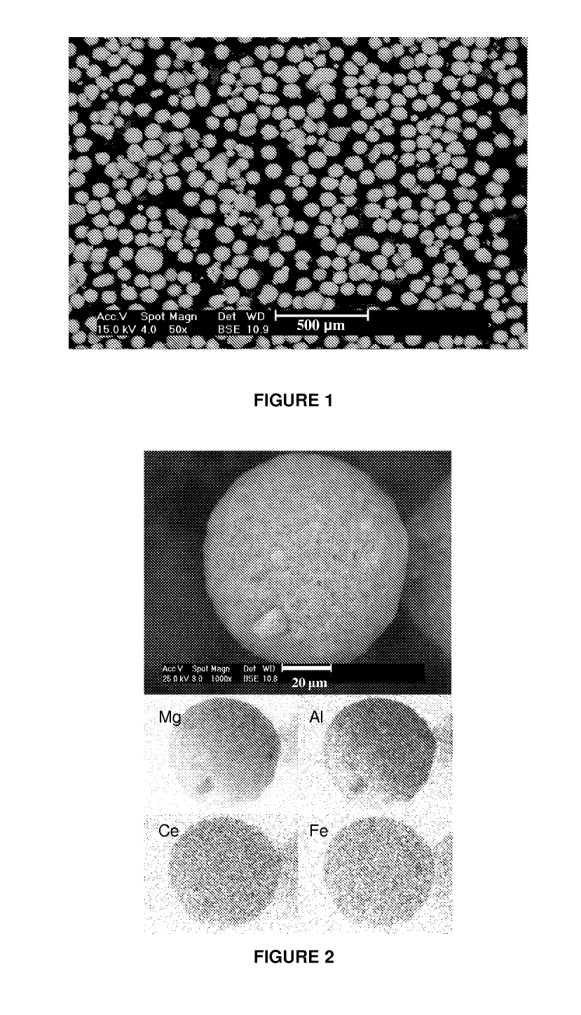

FIG. 1 displays SEM image of a spray dried MAC sample, evidencing the formation of spherical bodies. Such particles exhibit an average particle diameter in the range 80 to 100 microns, cfr. FIG. 2. According to the global, linear chemical mapping across the microsphere particle effectuated by EDS (FIG. 2), no dark zones or metallic clusters are observed, which evidences the absence of enrichment or segregation of the metallic components in their atomic form; in other words, metallic species are well dispersed in the solids.

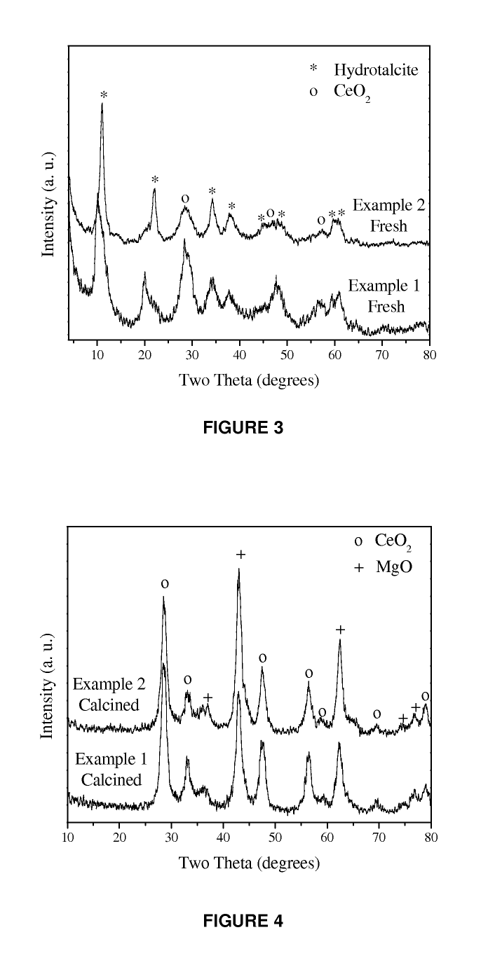

The XRD of microspheres prior to calcination (in the fresh form) confirms that hydrotalcite-like materials are produced, cfr. FIG. 3. Several peaks that correspond to CeO₂ are also observed. The values of crystal sizes and corresponding cell parameters of MgO and CeO₂ of microspheres of MACs in the fresh form are displayed in Table 1. FIG. 4 depicts the XRD patterns of microspheres calcined at 732° C. for 4 h. After calcination, multimetallic anionic clays transform into a MgO solid solution containing highly dispersed Fe(III) and Al(III) cations. The presence of CeO₂ as a separate phase is observed as well. Table 2 presents values of crystal sizes and corresponding cell parameters for MgO and CeO₂ of the calcined microspheroidal bodies.

Table 3 embodies information related to the chemical composition, specific surface area as well as mechanical properties, i.e., apparent bulk density (ABD) and AI (attrition index), of calcined microspheres produced by the procedure disclosed in this example. They exhibit an ABD in the range 0.5-1.0 g/cm³ with an AI lower than 2.

### Example 2

This example discloses preparation and shaping of a MAC adjusting its composition to control SOₓ emissions in conditions of oxygen excess in relation to the operation of the regenerator of fluid catalytic cracking units, i.e., full combustion mode. 62.2 g of acetic acid (85%) are dissolved in 1.92 L of H₂O. Then 383.24 g of MgO are added and stirred at 500 rpm for 1 h (A). 182.16 g of Fe(NO₃)₃.9H₂O together with 219.58 g of cerium nitrate solution (22.77% Ce) are dissolved separately in 4.8 l of water. Once the iron nitrate is dissolved, 197.61 g of HiQ-31 boehmite are added and the mixture is stirred at 500 rpm for 1 h (B). The gel product (B) is mixed with the product (A). Temperature is maintained at 100° C. and the mixture is stirred at 500 rpm while it is passed through an in-line high shear mixer for 3 h. The slurry is subsequently spray dried with hot air at 400° C. and a feed pressure of 120 psi. The spray dried microspheres are calcined at 732° C. for 4 h.

FIG. 1 and FIG. 2 present XRD patterns of the sample prepared according to this example before and after calcination, respectively. In the latter, MgO and CeO₂ are clearly detected. Calcined microspheres possess an apparent bulk density in the range 0.5-1.2 g/cm³ and attrition index lower than 2 as displayed in Table 3. The chemical composition, as well as physical and mechanical properties of the sample described in this example, are also shown in Table 3.

### Example 3

This example shows the effectiveness of the additive produced according to Example 1 for reducing SOₓ emissions generated in a pilot scale activity test. A distinctive, particular aspect of the test of this example is that the pilot unit regenerator was operated with an oxygen deficiency with respect to the amount required by stoichiometry to burn the coke that deposits on the catalyst, i.e. partial combustion mode. In order to perform the test under realistic conditions, an industrial gas oil containing about 2 wt % sulfur was used as feed while the pilot unit was loaded with an equilibrium catalyst Ecat composed by REUSY zeolite. The properties of the gas oil are displayed in Table 4 whereas those of the Ecat are presented in Table 5. The values of the key operating conditions were the following: feed preheating temperature of 170° C., gas oil inlet flow rate of 1.2 kg/h, catalyst to oil ratio of 10, reaction temperature of 520° C., dense bed regenerator temperature of 690° C., riser pressure 250 kPa, flue gas CO₂ to CO of 8.0 vol/vol. The latter warrants the partial combustion mode of the regenerator of the pilot unit.

The test was effectuated according to the following procedure:
(1) 3000 g of decoked and dry Ecat were loaded into the pilot plant and then fluidized with nitrogen. Once the Ecat fluidized properly, the feed injection at the bottom of the riser was commenced while the operating conditions were set to the defined values.
(2) After meeting the defined operating conditions and having reached a steady-state operation in the pilot unit operation, the test commenced formally. The unit was run for a 2 h period wherein the composition of the combustion gases from the regenerator was continuously monitored to obtain a SO₂ concentration baseline in the absence of any additive.
(3) When the 2 h period was over, 6 g of the additive produced according to Example 1 (0.2 wt % of nominal blend) was introduced into the pilot unit and the test was continued for 4 h. The evolution of the SOₓ emissions out of the regenerator was also monitored during that period of time. For comparison purposes, a commercial additive designated Reference was used reference and tested following the same procedure and identical operating conditions as described above.

The data of the evolution SO₂ emissions in the flue gas as a function of time are plotted in FIG. 5. Clearly, when the pilot plant catalytic inventory consists only of Ecat, SO₂ concentration is practically constant with an average value of 1470 ppm. After blending the additives with the main catalyst a clear and sharp decrease in the SO₂ emissions is observed reaching a minimum value after about 4 min. The minimum values of SO₂ emissions are equal to 382 and 339 ppm SO₂ for additive of Example 1 and Reference, respectively. After the minimum in SO₂ concentration is reached, the capacity of additives to adsorb SO₂ gradually declines, which is evidenced by an increase in the SO₂ concentration with time. The performance of the additives for this testing was qualified by means of the following set of parameters:

% SOₓ reduction: corresponds SO₂ emissions reduction, in ppm of SO₂, observed upon additive addition, respect to SO₂ ppm emitted when no additive is present, i.e. baseline SO₂ emissions.

Adsorption capacity: calculated as the ppm of SO₂ removed by the additive, compared to baseline SO₂ emissions, per unit mass of additive used.

Deactivation rate: indicates the decay of the additive's adsorption capacity to remove SO₂ emissions with respect to time per mass of additive used.

Values of these parameters are presented in Table 6. Additive produced in accordance with Example 1 has a maximum % SOₓ reduction of 74 by 77 of the commercial counterpart. The adsorption capacity of the sample of Example 1 was 182 ppm_{SO2removed}/g_{addit} while Reference reported 188_{SO2removed}/g_{addit}. The deactivation rates computed at initial conditions, i.e., when the maximum % SOₓ reduction is observed, correspond to 2.7 ppm_{SO2removed}/(g_{addit} min) for the additive of Example 1 and to 3.2 ppm_{SO2removed}/(g_{addit} min) for the commercial Reference.

TABLE 1
Cell parameters and crystal size of additives of Examples
1 and 2 without calcinations (in the fresh form).

| | a (Å) | c (Å) | a (Å)* | L003 (Å) | L110 (Å) | L111 (Å)* |
|---|---|---|---|---|---|---|
| Example 1 | 3.110 | 23.339 | 5.415 | 58 | 71 | 36 |
| Example 2 | 3.070 | 23.478 | 5.402 | 84 | 47 | 78 |

*CeO₂

TABLE 2
Cell parameters and crystal size of additives of Examples 1 and 2.

| Sample | a (Å)‡ | a (Å)† | L200 (Å)‡ | L111 (Å)† |
|---|---|---|---|---|
| Example 1 | 4.205 | 5.392 | 58 | 56 |
| Example 2 | 4.199 | 5.392 | 74 | 71 |

‡MgO,
†CeO₂

TABLE 3
Physical-mechanical properties and chemical composition
of additives disclosed in Examples 1 and 2.

| | | | | Surface | | | | |
|---|---|---|---|---|---|---|---|---|
| Sample | ABD | Al 1 h ^{a} | Al 2 h ^{b} | Area (m²/g) | MgO | Al₂O₃ | Fe₂O₃ | CeO₂ |
| Example 1 | 0.9 | 1.4 | 1.6 | 150 | 57 | 17 | 10 | 16 |
| Example 2 | 1.2 | 1.4 | 1.3 | 140 | 60 | 22 | 8 | 10 |

^{a} Low severity Grace Index, i.e., postreatment with 21 slpm of air for 1 h
^{b} High severity Grace Index, i.e., postreatment under 24 slpm of air for 2 h.

TABLE 4
Bulk properties of the industrial gas oil used as feed for the DCR pilot
unit catalytic tests.

| Property | Value |
|---|---|
| Specific gravity (20/4° C.) | 0.9203 |
| °API | 21.79 |
| ASTM D-160 distillation, ° C.: | 269/391/440/471/505/555/575 |
| IBP/T₁₀/T₃₀/T₅₀/T₇₀/T₉₀/FBP | |
| K-UOP | 11.98 |
| Average molecular mass | 481 |
| Refraction index at 20° C. | 1.5145 |
| Aniline temperature, ° C. | 98 |
| Sulfur, % wt | 2.0 |
| Nitrogen, ppm | 1316 |
| Conradson carbon, % wt | 0.26 |
| Metals, ppm: Fe/Na/Ni/V | 0.63/0.89/0.29/1.56 |

TABLE 5
Properties of the equilibrium catalyst (Ecat) used for the DCR pilot unit
catalytic tests.

| Property | Value |
|---|---|
| MAT activity | 68 |
| Total specific surface area, m²/g | 140 |
| Pore volume, cm³/g | 0.15 |
| Unit cell size (UCS), nm | 2.433 |
| Apparent bulk density (ABD), g/cm³ | 0.96 |
| Metals, ppm: Ni/V/Na/Fe | 571/2900/2400/3500 |

TABLE 6
Catalytic properties for SOₓ reduction measured in pilot plant tests on
the additives prepared in Examples 1 and 2.

| | | | |
|---|---|---|---|
| | % SOₓ | Adsorption capacity, | Initial deactivation rate, |
| Additive | reduction | ppm_{SO2 removed}/g_{addit} | ppm_{SO2 removed}/(g_{addit} min) |

Regenerator operated in partial combustion mode

| | | | |
|---|---|---|---|
| ADD-PC^{a} | 74 | 182 | 2.7 |
| Reference | 77 | 188 | 3.2 |

Regenerator operated in full combustion mode

| | | | |
|---|---|---|---|
| ADD-FC^{b} | 80 | 166 | 0.7 |
| Reference | 70 | 147 | 1.1 |

^{a}Additive of Example 1 used in partial combustion mode
^{b}Additive of Example 2 used in full combustion mode

### Example 4

This example demonstrates the use of the additive produced according to Example 2 for abating SOₓ emissions generated in a pilot scale activity test. A distinctive, particular aspect of the test of this example is that the pilot unit regenerator was operated with an excess of oxygen relative to the amount required by stoichiometry to burn the coke that deposits on the catalyst, i.e. full combustion mode.

The test disclosed in this example was performed following the procedure given in Example 3. Except for the combustion mode of the regenerator, operating conditions as well as feed and catalyst properties were identical to those mentioned in Example 3. In order to ensure the operation of the regenerator of the pilot unit in the full combustion mode a concentration of oxygen in the flue gas was maintained in 2.0 vol %. The commercial additive, Reference, cited in Example 3 was examined under the same protocol and at the same operating conditions as a comparison.

FIG. 6 shows the values of flue gas SO₂ emissions vs. time. During the first 2 h of the test, when the pilot plant catalytic inventory is only composed of main catalyst Ecat, SO₂ emissions are practically constant with an average value of 1250 ppm. When the additive is added to the pilot unit, the SO₂ concentration sharply decreases and a minimum value is attained after about 4 minutes. The minimum values for the SO₂ concentration amounts to 256 ppm sample of Example 2 and 351 ppm for the reference additive. After reaching a minimum in SO₂ emissions, additives deactivate and the concentration of SO₂ in the flue gas gradually increases.

Table 6 contains the values of the set of parameters defined in Example 3 to qualify the performance of the additives for SOₓ reduction. Additive of Example 2 reports a maximum % SOₓ reduction of as much as 80 while for the commercial counterpart this parameter is 70. The adsorption capacity amounted to 166 ppm_{SO2removed}/g_{addit} for the sample of Example 2 and 147 ppm_{SO2removed}/g_{addit} for Reference. The deactivation rates computed at initial conditions, i.e., when the maximum % SOₓ reduction is observed, correspond to 0.7 ppm_{SO2removed}/(g_{addit} min) for the material produced according to Example 2 and to 1.1 ppm_{SO2removed}(g_{addit} min) for the commercial one.

### Example 5

This example demonstrates the utility of the additive produced according to Example 1 for SOₓ reduction emissions in a pilot scale stability test wherein, in contrast to the test of Example 3, more than one additive addition is required.

Feed and catalyst properties as well as operating conditions used in the test were the same as the ones described in Example 3. Concerning to the operation of the regenerator, a CO₂ to CO ratio of 8.0 vol/vol was maintained, matching a partial combustion mode.

The test was performed in accordance the following sequence:
(1) 3000 g of decoked and dry Ecat were loaded into the pilot plant and then fluidized with nitrogen. Once the catalyst is properly fluidized, the feed was injected at the bottom of the riser and the operating conditions were set to the required values.
(2) When a steady-state in the pilot plant operation was met, the test started formally. The unit was then run for 2 h where no additives are present in order to obtain a baseline in flue gas SO₂ emissions.
(3) The end of the 2 h period was followed by a second period of 32 h wherein the SO₂ concentration the gases leaving the regenerator was maintained below 400 ppm via periodic additions of a constant amount of additive produced according to Example 1 into the pilot plant. Such additions were necessary since additives deactivation and losses occurs during continuous operation.

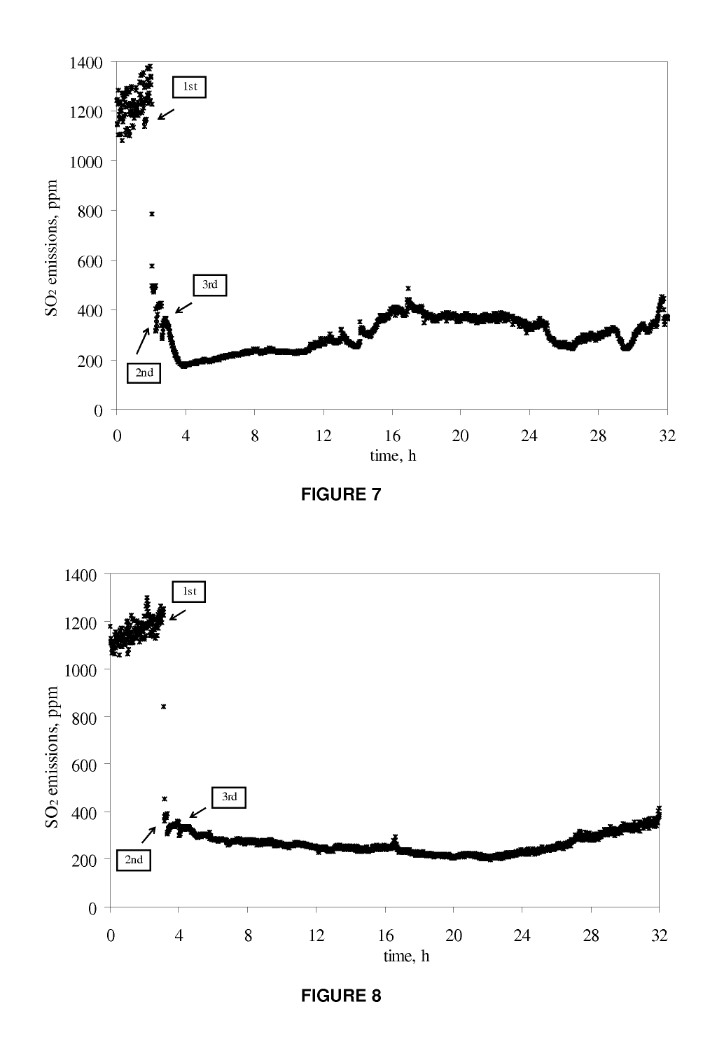

FIG. 7 shows that at the end of the 2 h period, a first addition of 15 g of additive of Example 1 was sufficient to decrease the SO₂ concentration from about 1200 ppm to a value below 400 ppm. Two additions more of this additive were required to maintain SO₂ emissions below 400 ppm (see Table 7). This testing was designed to quantify the adsorption efficiency for reducing SOₓ emissions, the latter is defined as the mass amount of SO₂ removed related to the mass of additive used for a period of time. Results summarized in Table 7 indicate that the accumulated efficiency for SO₂ removal of the additive produced in Example 1 was equal to 2.39 g_{SO2}/g_{additive}.

TABLE 7
Efficiency for SO₂ emissions reduction measured in pilot plant on
additives of Examples 1 and 2.

| | ADD-PC^{a} | | ADD-FC^{b} | |
|---|---|---|---|---|
| additive | Time | efficiency, | Time | efficiency, |
| addition | delay, h | g_{SO2removed}/g_{addit} | delay, h | g_{SO2removed}/g_{addit} |
| 1-2 | 0.23 | 0.012 | 0.18 | 0.017 |
| 2-3 | 0.35 | 0.026 | 0.63 | 0.067 |
| 3-end of testing | 29.1 | 2.36 | 27.5 | 3.17 |
| Accumulated | — | 2.39 | — | 3.25 |

^{a}Additive of Example 1 used in partial combustion mode.
^{b}Additive of Example 2 used in full combustion mode.

### Example 6

This example shows the additive of Example 2 for SOₓ emissions abatement through a pilot plant stability test following a methodology analogous to the one described in Example 5. The test of the current example was carried out with the feed and catalyst described in Example 3. Operating conditions were set to the values outlined in Example 3 except that the regenerator was operated in the full combustion mode by having an excess of oxygen in the flue gas equal to 3.0 vol %.

As illustrated in FIG. 8, additive of Example 2 was added three times to the pilot unit in order to keep the SO₂ emissions below 400 ppm, initiating at baseline level of 1150 ppm of SO₂. Values in Table 8 show that efficiency for SO₂ removal, calculated as explained in Example 5 amounted to 3.25 g_{SO2}/g_{additive}.

TABLE 8
Effect of the addition of additives of Examples 1
and 2 on main cracking during pilot plant tests.

| | ADD-PC^{a} | | | ADD-FC^{b} | | |
|---|---|---|---|---|---|---|
| | Run time, h | | | | | |
| | | | Relative | | | Relative |
| | | | Varia- | | | Varia- |
| | 1 | 32 | tion^{c} | 1 | 32 | tion^{c} |
| Feed conversion, wt % | 68 | 67.6 | −0.6 | 71.1 | 71.6 | 0.7 |
| Products yield, wt % | | | | | | |
| Dry gas | 2.9 | 3 | 3.4 | 3.2 | 3.1 | −3.1 |
| Methane | 1.06 | 1.06 | 0.0 | 1.14 | 1.11 | −2.6 |
| Hydrogen | 0.14 | 0.15 | 7.1 | 0.15 | 0.15 | 0.0 |
| LPG | 11.7 | 12.3 | 5.0 | 14.9 | 14.4 | −3.4 |
| C₃s | 5.1 | 5.1 | 0.0 | 6.3 | 5.9 | −6.3 |
| C₄s | 6.6 | 7.2 | 9.1 | 8.6 | 8.5 | −1.2 |
| Dry gas + LPG | 14.6 | 15.3 | 4.8 | 18.1 | 17.5 | −3.3 |
| Gasoline (35-221° C.) | 47.4 | 45.6 | −3.8 | 45.3 | 46.3 | 2.2 |
| LCO (221-343° C.) | 18.9 | 18.7 | −1.1 | 17.6 | 17.5 | −0.6 |
| HCO (343° C.+) | 13.1 | 13.7 | 4.6 | 11.3 | 10.9 | −3.5 |
| Coke | 4.6 | 4.7 | 2.2 | 6.1 | 6.2 | 1.6 |

Data at 1 h corresponds to main cracking on Ecat while data at 32 h corresponds to additive/main catalyst blends.
^{a}Additive of Example 1 used in partial combustion mode.
^{b}Additive of Example 2 used in full combustion mode.
^{c}Calculated as the difference of feed conversion, delta coke or product yield at 1 h minus the data at 32 h related to the data at 1 h.

### Example 7

This example shows the effect on the main cracking of blending the additive produced in Example 1, with a main catalyst through a pilot scale catalytic cracking test in which an industrial feed and realistic operating conditions are utilized. During the stability test described in Example 5, feed conversion and product yields were determined after 1 h when no additive is are present in the pilot unit and at 32 h corresponding to the time of the maximum additive concentration in the pilot unit, namely, 45 g of additive and 3000 g of Ecat (1.5 wt % of additive, nominal blend).

Table 8 displays values of feed conversion and product (gases, gasoline, coke, LCO and HCO) yields measured in the absence of the additive of Example 1 and after adding 1.5 wt % of that sample to the pilot plant catalytic inventory. It is noted that neither the base feed conversion nor the base product yields are dramatically altered. Most of relative deviations related to the behavior of the main catalyst are below 5%.

### Example 8

This example demonstrates the impact on the main cracking of blending the additive produced in Example 2 by following the procedure exposed in Example 7 during the stability test referred in Example 6. Table 8 shows that values of base feed conversion and product (gases, gasoline, coke, LCO and HCO) yields are not significantly shifted by the incorporation of 1.5 wt % additive to the pilot unit catalytic inventory.

What is claimed is:

1. A composition useful to remove sulfur oxides contained in combustion gases, which is composed of multimetallic anionic clays (MACs) having the formula:
[MgₓAl_{y}Fe_{z}(OH)₂](Aⁿ⁻_{(y+z)/n})[CeO₂]ₚ.mH₂O
wherein Mg, Al and Fe are metals that constitute layers of the clay while Ce, as an oxidant promoter, is highly dispersed throughout the solid in the form of cerium oxide; Aⁿ⁻ denotes an anion located between the layers composed of the metal cations; n represents the interlaminar anion's negative electronic charge that may be from −1 to −8; m is the molecules of water present as hydration water or as water present in the interlaminar region and can be from 0 to 2; where x=0.667 to 0.833, y=0.001 to 0.275, z=0.055 to 0.256, p=0.029 to 0.110.

2. The composition of claim 1, which is shaped by spray drying to form microspheroidal bodies which exhibit suitable physical and mechanical properties to fluidize in a circulating fluidized bed.

3. The composition of claim 2, wherein the microspherical particles are calcined to form microspherical particles having an average diameter between 40 and 120 microns, an apparent bulk density in a range of 0.5 to 0.9 and an attrition index from 1 to 4.

4. A process for producing multimetallic anionic clays having the formula
[MgₓAl_{y}Fe_{z}(OH)₂](Aⁿ⁻_{(y+z)/n})[CeO₂]ₚ.mH₂O
wherein Mg, Al and Fe are metals that constitute layers of the clay while Ce, as an oxidant promoter, is highly dispersed throughout the solid in the form of cerium oxide; Aⁿ⁻ denotes an anion located between the layers composed of the metal cations; n represents the interlaminar anion's negative electronic charge that may be from −1 to −8; m is the molecules of water present as hydration water or as water present in the interlaminar region and can be from 0 to 2, the process comprising the steps of
(a) dissolving a water soluble divalent and/or trivalent metal precursor maintaining a water to solid mass ratio between 0.1-100, to 1) provide the necessary amount of divalent and/or trivalent cations for the formation of the multimetallic anionic clay, and 2) to supply the necessary characteristics to the reaction medium in order to facilitate the reaction between the soluble and insoluble precursors.
(b) incorporating a cerium salt together with the water soluble metallic precursors in (a),
(c) adding to the resulting solution of step (b) a water insoluble divalent and/or trivalent metal precursors in powder form, slurry form, or combination thereof, homogenizing the reaction mixture by mechanical agitation from 100 to 1000 rpm, at a temperature between 10 and 100° C., from 0.5 to 3 h, at atmospheric pressure in air atmosphere or under another gas stream to produce a gel,
(d) dispersing in acidified water containing a weak acid, one, two or more divalent metallic precursors in powder form, stirring the mixture at a rate in the range 100-1000 rpm, for 0.5-3 h, and at 10-100° C., to obtain a suspension,
(e) blending the gel obtained in step (c) with the suspension of step (d) maintaining the pH of the mixture between 6 and 12, and the temperature between 80 and 200° C., stirring the mixture at a rate of 100-1000 rpm, while the mixture passes through an in-line high shear mixer for 1-10 h,
(f) spray drying the mixture to produce the multimetallic anionic clays in the form of microspheroidal particles,
(g) calcining the microspheres produced in step (f) at 300 to 1000° C. for 1-24 h in the presence of air, oxygen, nitrogen, or combinations thereof to produce a solid solution composed of a mixture of multimetallic oxides.

5. The process of claim 4, wherein the cations Mg, Al and Fe are not segregated phases.

6. The process of claim 4, wherein x is in the range 0.667 to 0.833.

7. The process of claim 4, wherein y is in the range 0.001 to 0.275.

8. The process of claim 4, wherein z is in the range 0.055 to 0.256.

9. The process of claim 4, wherein cerium, in the form of the corresponding oxide, is dispersed throughout the solid.

10. The process of claim 4, wherein p is in the range 0.029 to 0.110.

11. The process of claim 4, wherein Aⁿ⁻ represents one or more organic and/or inorganic anions.

12. The process of claim 4, further comprising adjusting the pH of the blend by the addition of a weak acid or weak base selected from the group consisting of formic acid, acetic acid, nitric acid, oxalic acid, ammonium phosphate, phosphoric acid, ammonium hydroxide, urea, ammonium carbonate and ammonium acid carbonate.

13. A process for cracking hydrocarbons in a fluid cracking process, the process comprising feeding and fluidizing a catalytic cracking catalyst and the multimetallic anionic clay of claim 1, in a hydrocarbon feed containing 0.1 to 5.0 wt % sulfur in an amount effective to reduce, in situ, SOₓ emissions generated in a regenerator of a fluid catalytic cracking unit.

14. The process of claim 13, wherein the SOₓ is reduced 60-100%.

15. The process of claim 13, wherein the multimetallic anionic clay removes 50 to 185 ppm SO₂ per gram of the multimetallic anionic clay.

16. The process of claim 13, wherein the multimetallic anionic clay exhibits an initial deactivation for SOₓ reduction between 0.7 to 2.7 ppm of SO₂ per gram of multimetallic anionic clay per minute.

17. The process of claim 13, wherein the multimetallic anionic clay displays an SOₓ efficiency in a range of 2 to 4 g SO₂ removed per gram of the multimetallic anionic clay.

18. The process of claim 13, wherein the multimetallic anionic clay is added in an amount of up to 3 wt % based on the total amount of the catalyst without modifying feed conversion more than 1% relative to a baseline value.

19. The process of claim 13, wherein the multimetallic anionic clay is added in an amount of up to 3 wt % based on the weight of the catalyst without shifting the yield to dry gas in more than 4% relative to a baseline value.

20. The process of claim 13, wherein the addition of up to 3 wt % of the multimetallic anionic clay based on the weight of the catalyst does not modify the yield to LPG in more than 6% relative to a baseline value.

21. The process of claim 13, wherein the addition of up to 3 wt % of the multimetallic anionic clay based on the weight of the catalyst does not change the yield to gasoline in more than 4% relative to a baseline value.

22. The process of claim 13, wherein the addition of up to 3 wt % of the multimetallic anionic clay based on the weight of the catalyst does not modify the yield to coke in more than 3% relative to a baseline value.
